(19) United States
(12) Patent Application Publication
(10) Pub. No.: US 2009/0325604 A1
(43) Pub. Date: Dec. 31, 2009

(54) SYSTEM AND METHOD FOR SEARCHING A LOCATION OF A MOBILE ELECTRONIC DEVICE

(75) Inventor: CHIH-PU HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/475,499

(22) Filed: May 30, 2009

(30) Foreign Application Priority Data
Jun. 27, 2008 (CN) 200810302405.5

(51) Int. Cl. H04W 24/00

(52) U.S. Cl. 455/456.2

(57) ABSTRACT

A system and method for searching a location of a mobile electronic device sets a user-predetermined short message, and sets one or more user-predetermined telephone numbers. The system and method further starts an audible device and a light-emitting device of the mobile electronic device to output audible sound and light, so that a user can search for the mobile electronic device according to the audible sound and the light, in response to a determination that the incoming short message is identical with the user-predetermined short message, or in response to a determination that the number of times of one or more missed calls matches a predetermined number and that the telephone number of one or more missed calls matches the one or more user-predetermined telephone numbers.

### BACKGROUND

1. Technical Field

Embodiments of the present disclosure are related to electronic device management systems and methods, and particularly to a system and method for searching a location of the mobile electronic device.

2. Description of Related Art

A mobile electronic device is a pocket-sized computing device, which usually includes a small visual display for output and a miniature keyboard or touch screen for input. However, a user may forget where he/she left the mobile phone is deposited, then the user may spend much time to search for the mobile phone.

Therefore, there is a need for a system and method to overcome the aforementioned problem.

### BRIEF DESCRIPTION OF THE DRAWINGS

FIG. 1 is a block diagram of one embodiment of a mobile electronic device 1 comprising a system searching a location of the mobile electronic device.

FIG. 2 is a flowchart of one embodiment of a method for searching a location of the mobile electronic device using a short message.

FIG. 3 is a flowchart of one embodiment of a method for searching a location of the mobile electronic device using one or more missed calls.

### DETAILED DESCRIPTION

All of the processes described below may be embodied in, and fully automated via, function modules executed by one or more general purpose processors of a mobile electronic device. Some or all of the methods may alternatively be embodied in specialized hardware. The function modules may be stored in any type of computer-readable medium or other computer storage device.

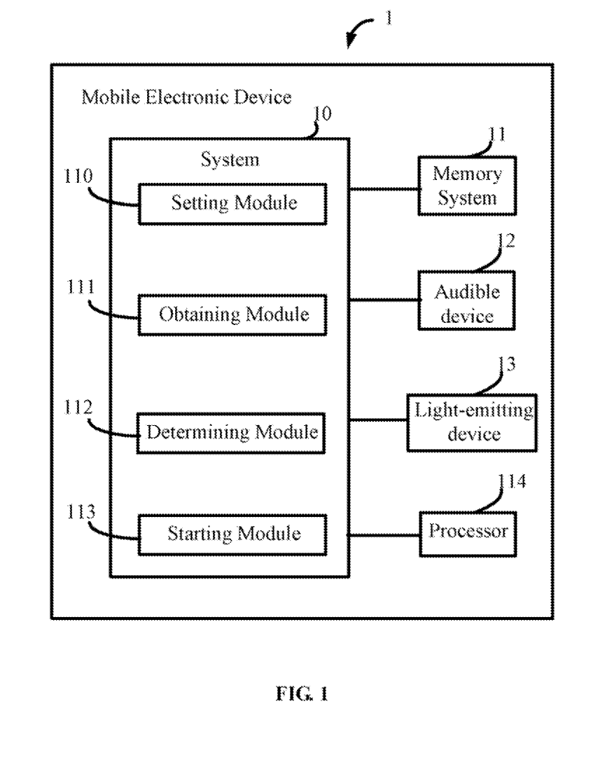

FIG. 1 is a block diagram of one embodiment of a mobile electronic device 1 comprising a system 10. The system 10 may be used to search a location of the mobile electronic device 1. In one embodiment, the mobile electronic device 1 includes a memory system 11, an audible device 12, and a light-emitting device 13. The audible device 12 is capable of outputting an audible sound, such as “I am here,” so as to facilitate locating the mobile electronic device 1. In one embodiment, the audible device 12 outputs the audible sound at the loudest volume of the mobile electronic device 1. The light-emitting device 13 is capable of emitting light, so as to also facilitate locating the mobile electronic device 1. In one embodiment, the emitted light may be, but not limited to, colored light.

The memory system 11 may be an internal memory system card or an external memory system card, such as a smart media card (SMC), a secure digital card (SDC), a compact flash card (CFC), a multi media card (MMC), a memory system stick (MS), an extreme digital card (XDC), and a trans flash card (TFC). Depending on the embodiment, the mobile electronic device 1 may be a mobile phone, a personal digital assistant (PDA), or any other portable electronic device with a communication function.

In one embodiment, the system 10 includes a setting module 110, an obtaining module 111, a determining module 112, and a starting module 113. One or more computerized codes of the modules 110-113 are stored in the memory system 11. One or more general purpose or specialized processors, such as a processor 114 executes the computerized codes of the modules 110-113 to provide one or more operations of the mobile electronic device 1.

The setting module 110 is operable to set a user-predetermined short message and one or more user-predetermined telephone numbers, and to set an audible sound corresponding to the user-predetermined short message and the one or more user-predetermined telephone numbers. In one embodiment, for example, the setting module 110 sets the user-predetermined short message “Hello, my phone, where are you,” sets two user-predetermined telephone numbers “1234567” and “2345678,” and sets the audible sound “I'm here” corresponding to the user-predetermined short message and the two user-predetermined telephone numbers.

The obtaining module 111 is operable to obtain an incoming short message or a telephone number of one or more missed calls from the mobile electronic device 1.

The determining module 112 is operable to determine if the incoming short message is identical with the user-predetermined short message, or determine if the number of times of the one or more missed calls matches a predetermined number, and if the telephone number of the one or more missed calls matches the one or more user-predetermined telephone numbers. The predetermined number is predetermined by a user. For example, the predetermined number may be “2.”

The starting module 113 is operable to start the audible device 12 of the mobile electronic device 1 to output the audible sound and start the light-emitting device 13 to emit light, so as to facilitate locating the mobile electronic device 1, in response to a determination that the incoming short message is identical with the user-predetermined short message, or in response to a determination that the number of times of the one or more missed calls matches a predetermined number and that the telephone number of the one or more missed calls matches the one or more user-predetermined telephone numbers. In one embodiment, for example, if the mobile electronic device 1 obtains an incoming short message, such as “Hello, my phone, where are you,” the starting module 113 starts the audible device 12 of the mobile electronic device 1 to output the audible sound “I'm here” and starts the light-emitting device 13 to generate light. In another example, if the mobile electronic device 1 is called by the telephone number “1234567” or “2345678” twice, the starting module 113 also starts the audible device 12 of the mobile electronic device 1 to output the audible sound “I'm here” and starts the light-emitting device 13 to generate light.

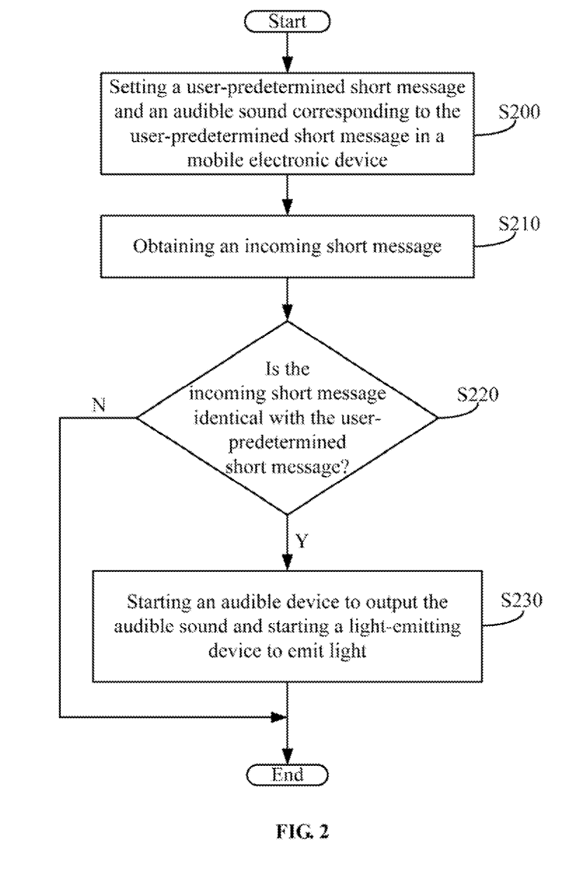

FIG. 2 is a flowchart of one embodiment of a method for searching a location of the mobile electronic device 1 using a short message. Depending on the embodiment, additional blocks may be added, while others deleted, and the blocks may also be executed in a different order than described.

In block S200, the setting module 110 sets a user-predetermined short message and set an audible sound corresponding to the user-predetermined short message. As mentioned above, the setting module 110 sets the user-predetermined short message “Hello, my phone, where are you,” and sets the audible sound “I'm here” corresponding to the user-predetermined short message.

In block S210, the obtaining module 111 obtains an incoming short message from the mobile electronic device 1. In one embodiment, the mobile electronic device 1 contains a short message inbox which receiving incoming short messages send by other communication device. The obtaining module 111 obtains the incoming short message form the short message inbox.

In block S220, the determining module 112 determines if the incoming short message is identical with the user-predetermined short message. In one embodiment, if the incoming short message is not identical with the user-predetermined short message, the procedure ends. For example, assuming that the incoming short message is “Hello,” then the procedure ends. Otherwise, the procedure goes to block S230. As mentioned above, assuming that the incoming short message is “Hello, my phone, where are you,” then the procedure goes to block S230.

In block S230, the starting module 114 starts the audible device 12 of the mobile electronic device 1 to output the audible sound and starts the light-emitting device 13 to generate light, so that the user can search for the mobile electronic device 1 according to the audible sound and the light. In one embodiment, if the audible device 12 of the mobile electronic device 1 outputs the audible sound “I am here” at the loudest volume, then the user can find the mobile electronic device 1 according to the audible sound. The user can also find the mobile electronic device 1 according to the light.

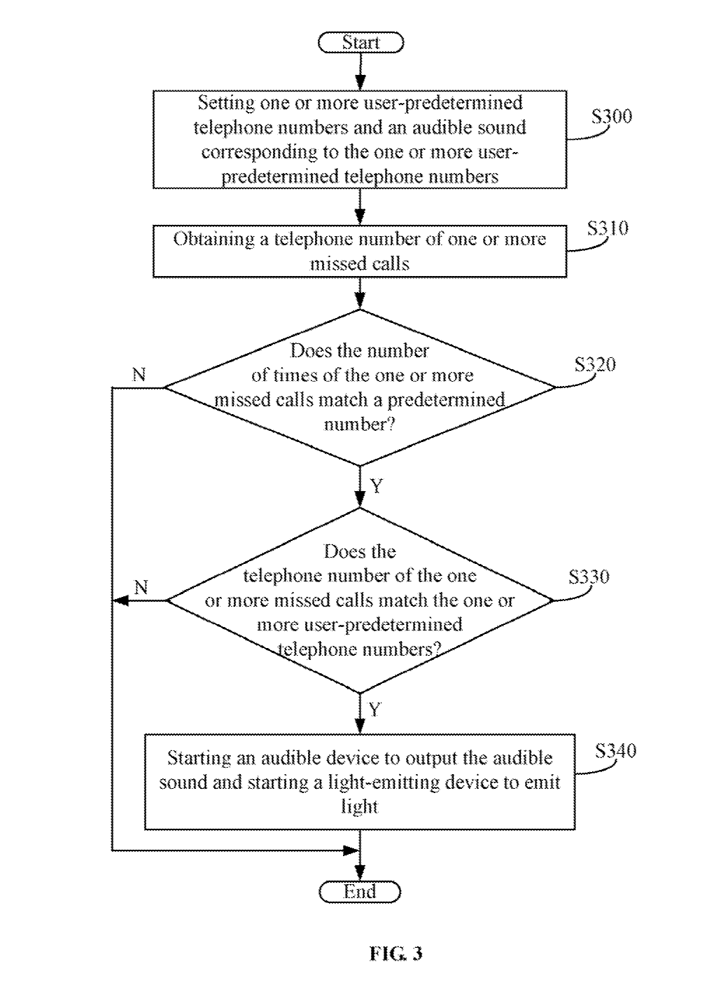

FIG. 3 is a flowchart of one embodiment of a method for searching a location of the mobile electronic device 1 using one or more missed calls.

In block S300, the setting module 110 sets one or more user-predetermined telephone numbers, and sets an audible sound corresponding to the one or more user-predetermined telephone numbers. As mentioned above, the setting module 110 sets two user-predetermined telephone numbers, such as “1234567” and “2345678,” and sets the audible sound corresponding to the two telephone numbers, such as “I'm here.”

In block S310, the obtaining module 111 obtains a telephone number of one or more missed calls from the mobile electronic device 1.

In block S320, the determining module 112 determines if the number of times of the one or more missed calls are equal to the predetermined number. In one embodiment, if the number of times of the one or more missed calls are not equal to a predetermined number, then the procedure ends. For example, if the predetermined number is “2,” and the user calls the mobile electronic device 1 only once, then the procedure ends. Otherwise, the procedure goes to block S330.

In block S330, the determining module 112 determines if the telephone number of the one or more missed calls matches the one or more user-predetermined telephone numbers. In one embodiment, if the telephone number of the one or more missed calls does not match the one or more user-predetermined telephone numbers, then the procedure ends. For example, if the mobile electronic device 1 is called by the telephone number “0123456,” then the procedure ends. If the telephone number of the one or more missed calls matches the one or more user-predetermined telephone numbers, then the procedure goes to block S340. For example, if the mobile electronic device 1 is called by the telephone number “1234567” or “2345678,” then the procedure goes to block S340.

In block S340, the starting module 113 starts the audible device 12 of the mobile electronic device 1 to output the audible sound and starts the light-emitting device 13 to emit light, so as to facilitate locating the mobile electronic device 1. As mentioned above, if the audible device 12 of the mobile electronic device 1 outputs the audible sound “I am here” at the loudest volume, then the user hears the audible sound and searches for the mobile electronic device 1 according to the audible sound. The user can also search for the mobile electronic device 1 according to the light.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for searching a location of a mobile electronic device, the mobile electronic device comprising a memory system storing a plurality of programs and a processor that executes one or more operations for the plurality of programs, the programs comprising:
a setting module operable to set a user-predetermined short message and one or more user-predetermined telephone numbers, and set an audible sound corresponding to the user-predetermined short message and the one or more user-predetermined telephone numbers;
an obtaining module operable to obtain an incoming short message or a telephone number of one or more missed calls from the mobile electronic device;
a determining module operable to determine if the incoming short message is identical with the user-predetermined short message, or to determine if the number of times of the one or more missed calls matches a predetermined number and if the telephone number of the one or more missed calls matches the one or more user-predetermined telephone numbers; and
a starting module operable to start an audible device to output the audible sound and start a light-emitting device to emit light, so as to facilitate locating the mobile electronic device according to the audible sound and the light, in response to a determination that the incoming short message is identical with the user-predetermined short message, or in response to a determination that the number of times of the one or more missed calls matches a predetermined number and that the telephone number of the one or more missed calls matches the one or more user-predetermined telephone numbers, wherein the audible device and the light-emitting device are components of the mobile electronic device.

2. The computing system of claim 1, wherein the audible device outputs the audible sound at the loudest volume of the mobile electronic device.

3. The computing system of claim 1, wherein the mobile electronic device is selected from the group consisting of a mobile phone and a personal digital assistant (PDA).

4. The computing system of claim 1, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).

5. A method for searching a location of a mobile electronic device, the method comprising:
(a) setting a user-predetermined short message and one or more user-predetermined telephone numbers, and setting an audible sound corresponding to the user-predetermined short message and the one or more user-predetermined telephone numbers;
(b) obtaining an incoming short message or a telephone number of one or more missed calls from the mobile electronic device;
(c) determining if the incoming short message is identical with the user-predetermined short message, or determining if the number of times of the one or more missed calls matches a predetermined number and if the telephone number of the one or more missed calls matches the one or more user-predetermined telephone numbers;
(d) starting an audible device to output the audible sound and starting a light-emitting device to emit light, so as to facilitate locating the mobile electronic device according to the audible sound and the light, in response to a determination that the incoming short message is identical with the user-predetermined short message, or in response to a determination that the number of times of the one or more missed calls matches a predetermined number and that the telephone number of the one or more missed calls matches the one or more user-predetermined telephone numbers, wherein the audible device and the light-emitting device are components of the mobile electronic device.

6. The method of claim 5, wherein the audible device outputs the audible sound at the loudest volume of the mobile electronic device.

7. The method of claim 5, wherein the mobile electronic device is selected from the group consisting of a mobile phone and a personal digital assistant (PDA).

8. The method of claim 5, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).

9. A storage medium having stored thereon instructions that, when executed by a mobile electronic device, causes the mobile electronic device to perform a method for searching a location of the mobile electronic device, the method comprising:
(a) setting a user-predetermined short message and one or more user-predetermined telephone numbers, and setting an audible sound corresponding to the user-predetermined short message and the one or more user-predetermined telephone numbers;
(b) obtaining an incoming short message or a telephone number of one or more missed calls from the mobile electronic device;
(c) determining if the incoming short message is identical with the user-predetermined short message, or determining if the number of times of the one or more missed calls matches a predetermined number and if the telephone number of the one or more missed calls matches the one or more user-predetermined telephone numbers;
(d) starting an audible device to output the audible sound and starting a light-emitting device to emit light, so as to facilitate locating the mobile electronic device according to the audible sound and the light, in response to a determination that the incoming short message is identical with the user-predetermined short message, or in response to a determination that the number of times of the one or more missed calls matches a predetermined number and that the telephone number of the one or more missed calls matches the one or more user-predetermined telephone numbers, wherein the audible device and the light-emitting device are components of the mobile electronic device.

10. The medium of claim 9, wherein the audible device outputs the audible sound at the loudest volume of the mobile electronic device.

11. The medium of claim 9, wherein the mobile electronic device is selected from the group consisting of a mobile phone and a personal digital assistant (PDA).

12. The medium of claim 9, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).
